(19) United States
(12) Patent Application Publication
(10) Pub. No.: US 2016/0080151 A1
(43) Pub. Date: Mar. 17, 2016

(54) Systems and Methods of Authentication of Communications

(71) Applicant: MASTERCARD INTERNATIONAL INCORPORATED, Purchase, NY (US)

(72) Inventors: Patrik Smets, Nijlen (BE); Patrick Mestré, Sart-Bernard (BE); Dave Roberts, Warrington (GB); Duncan Garrett, London (GB)

(21) Appl. No.: 14/850,286

(22) Filed: Sep. 10, 2015

(30) Foreign Application Priority Data
Sep. 15, 2014 (GB) 1416282.0

(51) Int. Cl. H04L 9/32; G06Q 20/38; G06Q 20/40; H04W 12/06

(52) U.S. Cl. CPC H04L 9/321; H04W 12/06; G06Q 20/3829; G06Q 20/401; G06Q 2220/00

(57) ABSTRACT

A system and method of authenticating a communication network comprising a first computing device, a second computing device and an intermediary computing device, wherein there is a first path between the first computing device and the intermediary computing device and a second path between the second computing device and the intermediary computing device. The method is executed at the intermediary computing device, and comprises receiving, from the first computing device, a first session key generated by the first computing device using a function, wherein an input to the function comprises an incremented variable; receiving, from the second computing device, data associated with a second session key generated by the second computing device using the function; determining that the first session key and the second session key are the same; and defining the communication network as authentic when the first session key and the second session key are the same.

### FIELD

The present disclosure generally relates to systems and methods of authentication of communications, and more particularly but not exclusively to authentication of communications in a transaction between an issuer and a Point of Interaction, and between a transaction device and a Point of Interaction in a payment transaction.

### BACKGROUND

This section provides background information related to the present disclosure which is not necessarily prior art.

In a typical payment transaction between a transaction device (e.g. a contact or contactless integrated circuit chip card) and a Point of Interaction (POI, e.g. a card payment terminal, an automated teller machine or an online payment terminal), transaction data is sent by the POI to an issuer for approval and verification. The response of the issuer to the POI, for example, to approve or decline the payment transaction, is sent back to the POI which can then take action accordingly.

However, if the communications between the issuer and the POI were intercepted by a fraudulent user, then the response from the issuer could be modified. For example, a response to decline a payment transaction could be changed to an approval. The POI would then approve the transaction as it is unable to verify that the response from the issuer is authentic. Generally, the fraud would be noticed when the payment transaction undergoes clearing, but this may be too late to prevent the fraudulent user from obtaining any goods or services paid for by the fraudulent payment transaction.

A typical payment transaction may also involve a user of the transaction device verifying their identity by entering a Personal Identification Number (PIN) or by undergoing biometric authentication (e.g. fingerprint or finger vein recognition, iris scanning, etc.) at the POI. The POI then sends the information identifying the user to the transaction device for verification. The transaction device can then respond to the POI as to whether the verification was successful or failed.

However, if the communications between the transaction device and the POI were intercepted by a fraudulent user, then the response from the transaction device could be modified. For example, the result of a PIN verification could be changed from failed to successful. Generally, the fraud would be noticed when the payment transaction undergoes clearing, but this may be too late to prevent the fraudulent user from obtaining any goods or services paid for by the fraudulent payment transaction.

The present disclosure has been devised to mitigate or overcome at least some of the above-mentioned problems.

### SUMMARY

This section provides a general summary of the disclosure, and is not a comprehensive disclosure of its full scope or all of its features. Aspects and embodiments of the disclosure are also set out in the accompanying claims.

According to an aspect of the present disclosure, there is provided a method of authenticating a communication network comprising a first computing device, a second computing device and an intermediary computing device, wherein there is a first path between the first computing device and the intermediary computing device and a second path between the second computing device and the intermediary computing device, the method being executed at the intermediary computing device and comprising: receiving, from the first computing device, a first session key, the first session key being generated by the first computing device using a function, wherein an input to the function comprises an incremented variable; receiving, from the second computing device, data associated with a second session key, the second session key being generated by the second computing device using the function; determining that the first session key and the second session key are the same; and defining the communication network as authentic in the event that the first session key and the second session key are the same.

Accordingly, in order to defraud the transaction, an attacker would have to tamper with both the session key received from the first computing device as well as the session key from the second computing device.

In some embodiments, the data associated with the second session key is the second session key. The step of determining may then comprise directly comparing the first session key and the second session key.

Alternatively, the data associated with the second session key is data signed by the second session key. The step of determining may then comprise inferring the second session key from the data signed by the second session key, and determining that the first session key and the second session key are the same. Inferring the second session key may comprise verifying the data signed by the second session key using the first session key. If the verification is successful, then the first session key and the second session key are the same.

In some embodiments, the incremented variable is a count of the number of transactions carried out by the first computing device. Alternatively, the incremented variable is a time.

In some embodiments, the first session key is received with data associated with a transaction. Optionally, the second session key is received with data associated with a transaction.

In some embodiments, the first computing device is a transaction device arranged to carry out transactions with the intermediary computing device.

In some embodiments, the second computing device is an issuer entity arranged to validate transactions between the transaction device and the intermediary computing device. Optionally, the intermediary computing device is a point of interaction.

A non-transitory computer-readable storage medium storing executable computer program instructions may be configured to implement the above method.

According to an aspect of the present disclosure, there is provided an intermediary computing device suitable for authenticating a communication network, the communication network comprising a first computing device, a second computing device and an intermediary computing device, wherein there is a first path between the first computing device and the intermediary computing device and a second path between the second computing device and the intermediary computing device, the intermediary computing device comprising: a first input, arranged to receive a first session key from the first computing device, the first session key being generated by the first computing device using a function, wherein an input to the function comprises an incremented variable; a second input, arranged to receive data associated with a second session key from the second computing device, the second session key being generated by the issuer using the function; a processor arranged to determine that the first session key and the second session key are the same, and define that the communication network is authentic in the event that the first session key is identical to the second session key.

Optionally, the data associated with the second session key is the second session key. The processor may then be arranged to determine that the first session key and the second session key are the same by directly comparing the first session key and the second session key.

Alternatively, the data associated with the second session key is data signed by the second session key. The processor may then be arranged to determine that the first session key and the second session key are the same by inferring the second session key from the data signed by the second session key, and determining that the first session key and the second session key are the same. Inferring the second session key may comprise verifying the data signed by the second session key using the first session key. If the verification is successful, then the first session key and the second session key are the same.

In some embodiments, the first input and the second input are the same.

Additionally, the intermediary computing device may comprise an output arranged to output a verification message to the first computing device or the second computing device, wherein the verification message comprises whether the communication was successfully authenticated by the intermediary computing device.

Optionally, the intermediary computing device may comprise a display and an output arranged to output a transaction outcome to the display.

Further areas of applicability will become apparent from the description provided herein. The description and specific examples and embodiments in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

In order that the disclosure may be more readily understood, embodiments of the disclosure will now be described in more detail, by way of example only, and with reference to the following figures in which:

FIG. 1 is a schematic block diagram of an environment in which an embodiment of the present disclosure is carried out;

FIG. 2 is a schematic block diagram of a Point of Interaction according to an embodiment of the present disclosure;

FIG. 3 is a schematic block diagram of a transaction device according to an embodiment of the present disclosure;

FIG. 4 is a schematic block diagram of an issuer according to an embodiment of the present disclosure; and

FIGS. 5 to 8 are data flows according to embodiments of the present disclosure.

### DETAILED DESCRIPTION

Example embodiments will now be described more fully with reference to the accompanying drawings.

The present disclosure provides a system and method for authenticating responses in data communications between a first party and a second party via an intermediary by signing the responses with a session key independently generated by each party and sent to the intermediary for validation. In the embodiments described below, the intermediary is a POI, the first party is a transaction device and the second party is an issuer. Accordingly, in order to defraud the transaction, an attacker would have to tamper with both the communication channel between the transaction device and the POI as well as the communication channel between the POI and the issuer.

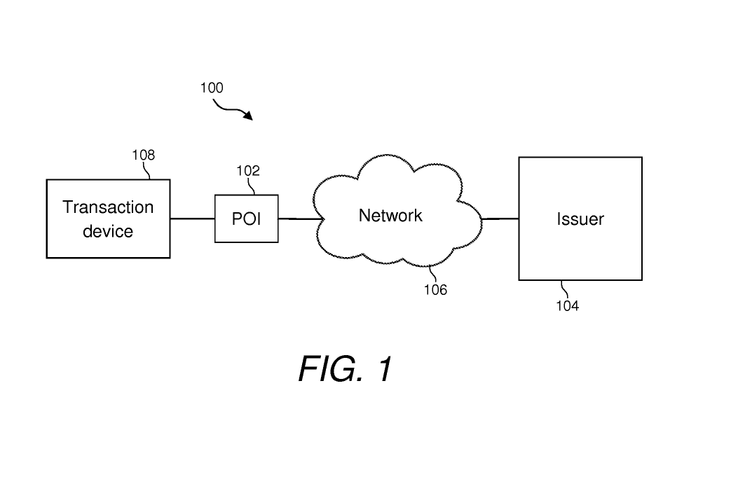

FIG. 1 shows an example environment 100 in which a transaction can occur. The environment comprises a Point of Interaction (POI) 102 and an issuer 104 each with separate data connections to a network 106. The network 106 allows two way data transfer between any of the entities connected to it. For example, the network 106 may be a local area network, wide area network or the Internet.

The POI 102 is arranged to form temporary communication channels with a transaction device 108 to carry out transactions. The POI 102 may be a card payment terminal, an automated teller machine or an online payment terminal, and the transaction device 108 may be a contact or contactless integrated circuit chip card. During a transaction, the POI 102 sends and receives transaction data to and from the issuer 104 via the network 106.

The issuer 104 is arranged to process the transaction data and determine whether the transaction should be allowed to complete or be rejected. For example, if there are insufficient funds to complete the transaction or the transaction device has expired, etc. The issuer 104 sends a response communication to the POI 102 comprising its determination of whether the transaction should be approved or declined.

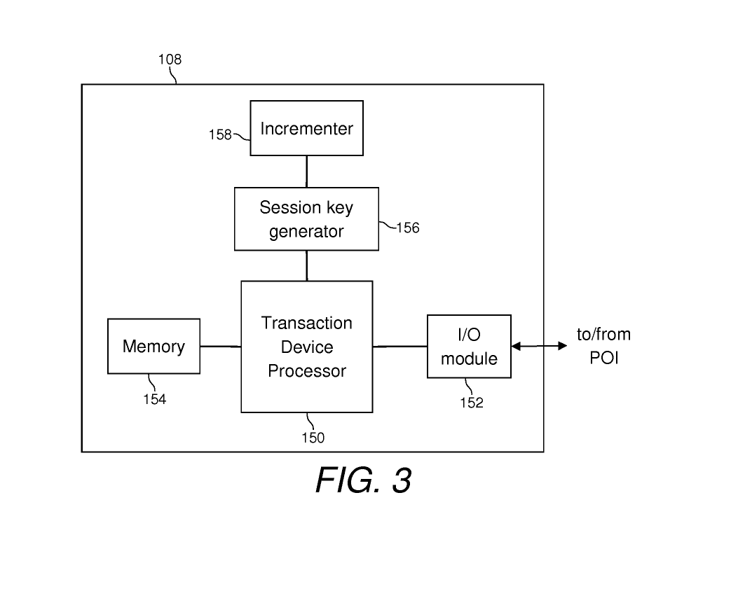

The transaction device 108 is associated with a user. Accordingly, the transaction device is arranged to only allow the user to carry out transactions (see also the description relating to FIG. 3 below).

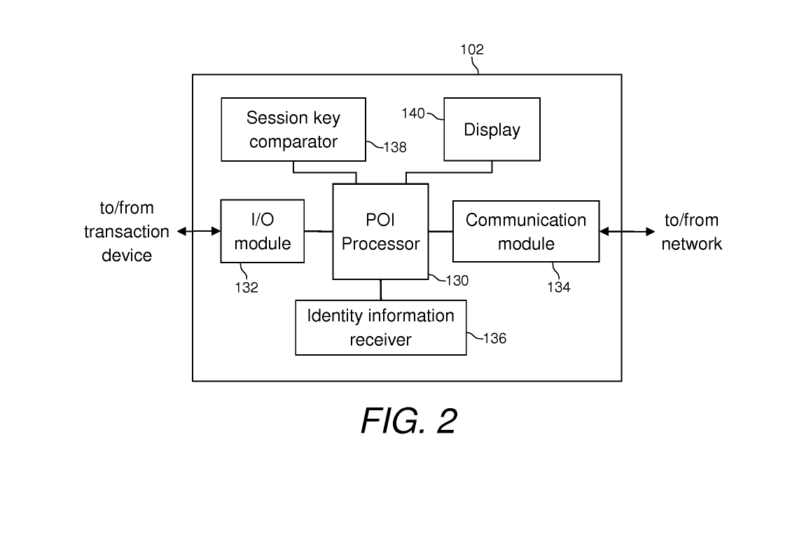

FIG. 2 shows the POI 102 in greater detail. The POI 102 comprises a POI processor 130 for controlling the POI 102. The POI 102 further comprises an input/output (I/O) module 132 for communicating with the transaction device 108, a communication module 134 for communicating with the network 106, an identity information receiver 136 for verifying the identity of a user of the transaction device 108, a session key comparator 138 for validating received session keys and a display 140 for providing visual feedback to users. The I/O module 132, the communication module 134, the identity information receiver 136, the session key comparator 138 and the display 140 are each connected to the POI processor 130.

The identity information receiver 136 is arranged to obtain verifiable information associated with the user. For example, the identity information receiver 136 may comprise a PIN-entry pad, a keyboard suitable for password input, a fingerprint scanner, a finger vein scanner or an iris scanner.

FIG. 3 shows the transaction device 108 in greater detail. The transaction device 108 comprises a transaction device processor 150 for controlling the transaction device 108. The transaction device 108 further comprises an I/O module 152 for communicating with the POI 102, a memory 154 for securely storing data, a session key generator 156 and an incrementer 158. The I/O module 152, the memory 154 and the session key generator 156 are each connected to the transaction device processor 150. The incrementer 158 is connected to the session key generator 156 which uses the incrementer 158 to generate a session key for a transaction.

The memory 154 stores information associated with the user, for example a PIN or biometric data. During transactions, the POI 102 obtains information associated with the user and sends the information to the transaction device 108 for verification with the data stored in the memory 154. The transaction device processor 150 is arranged to determine whether the received information corresponds to an authorized user of the transaction device 108.

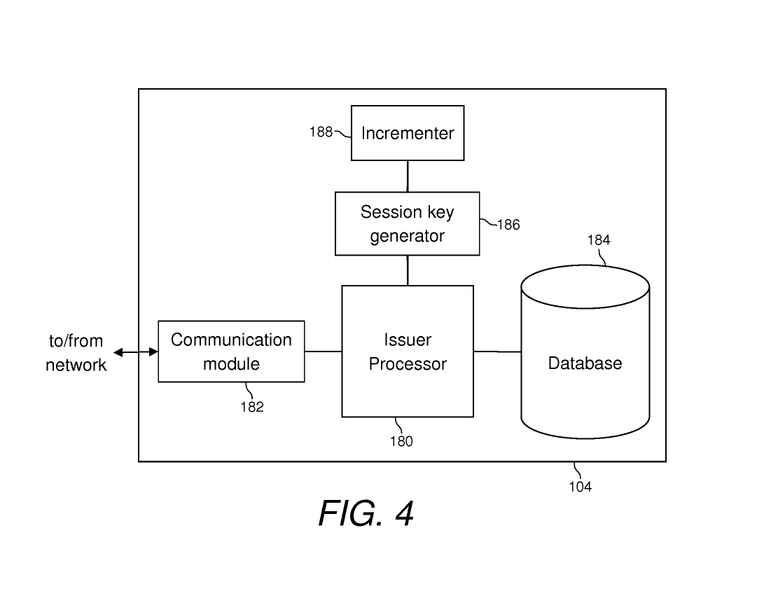

FIG. 4 shows the issuer 104 in greater detail. The issuer 104 comprises an issuer processor 180 for controlling the issuer 104. The issuer 104 further comprises a communication module 182 for communicating with the network 106, a database 184, a session key generator 186 and an incrementer 188. The communication module 182, the database 184 and the session key generator 186 are each connected to the issuer processor 180. The incrementer 188 is connected to the session key generator 186 which uses the incrementer 188 to generate a session key for a transaction.

The database 184 comprises information associated with the transaction device 108, such as a transaction device number, a security code (e.g. a card security code, card verification data, a card verification number, a card verification value, a card verification value code, a card verification code a or signature panel code), a name of an authorized user, an address of an authorized user, time validity and an available balance of credit of the user.

The session key generator 156 of the transaction device 108 and the session key generator 186 of the issuer 104 are arranged in substantially the same way to perform a function to generate a session key that is different for each transaction. The input to the function is obtained from the incrementers 158 and 188 of the transaction device 108 and the issuer 104 respectively. The incrementers 158 and 188 independently count the total number of transactions carried out using the transaction device 108. The incrementer 158 of the transaction device 108 counts the number of transactions by counting the number of times it carries out (successful or unsuccessful) transactions with POIs. The incrementer 188 of the issuer 104 counts the number of transactions by counting the number of times it is requested to approve or deny a transaction. Accordingly, the independent counts maintained by the incrementers 158 and 188 remain synchronized.

The incrementers 158 and 188 may both be configured to ascend the same predetermined number sequence using the transaction number to determine the position in the number sequence. In other embodiments, the incrementers 158 and 188 may be clocks that are synchronized at an initial time.

In the examples below, the communications between the transaction device 108 and the POI 102, and between the issuer 104 and the POI 102, are referred to as ‘responses’. Further, the examples below do not illustrate all communications that occur during a transaction for clarity.

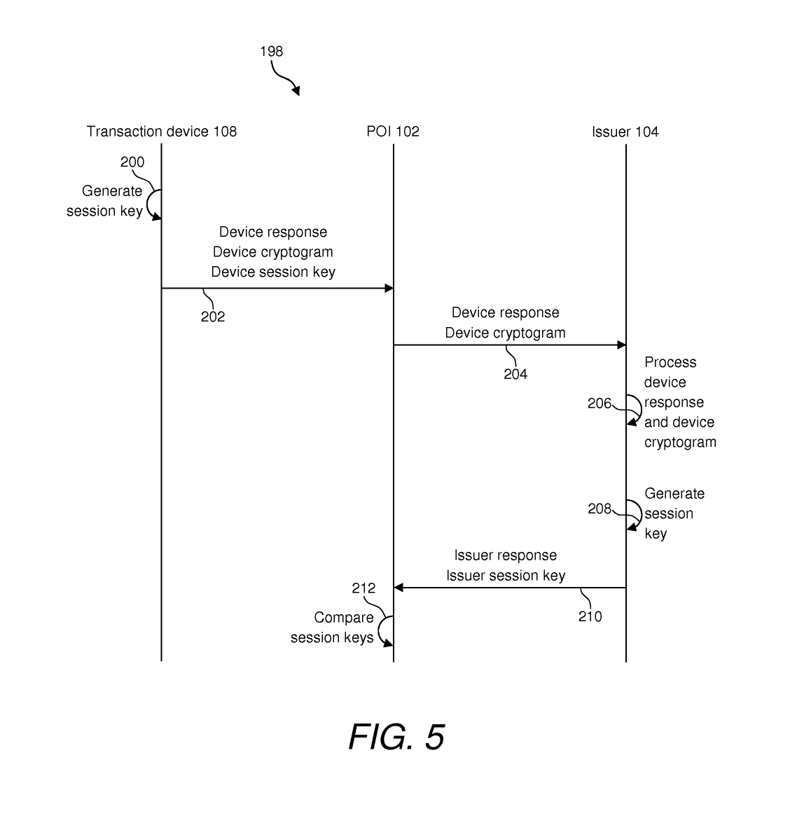

FIGS. 5 to 8 below show example data flows between the transaction device 108, POI 102 and issuer 104 and the generation of session keys by the issuer 104 and the transaction device 108. It is noted that the session keys can be generated by the issuer 104 and the transaction device 108 respectively at any time prior to them being sent to the POI 102, and not necessarily in the sequence shown in data flows 198 and 250.

FIG. 5 shows an example dataflow 198 between the transaction device 108, the POI 102 and the issuer 104 in which the communications from the issuer 104 are authenticated. Once the transaction device 108 and the POI 102 form a temporary connection between the I/O module 132 of the POI 102 and the I/O module 152 of the transaction device 108 for carrying out a payment transaction, the session key generator 156 of the transaction device 108 generates, at Step 200, a session key for the transaction. Then the transaction device 108 sends, at Step 202, a device response, a device cryptogram and a session key to the POI 102. The POI 102 forwards, at Step 204, the device response and the device cryptogram to the issuer 104 via the network 106.

Following this, the issuer 104 processes, at Step 206, the device response and the device cryptogram to check if the transaction is valid. The issuer 104 uses the information associated with the transaction device in the database 184 to determine whether the transaction should be approved or denied based on the transaction data comprising the device response and the device cryptogram.

The session key generator 186 of the issuer 104 generates, at Step 208, a session key for the transaction. The response of the issuer regarding the allowability of the transaction and the session key are then sent, at Step 210, back to the POI 102. The POI 102 then compares, at Step 212, the session key from the transaction device 108 and the session key from the issuer 104 to determine whether they match. If they match, then the POI 102 can trust that the issuer response is valid. Accordingly, the response received by the POI 102 regarding whether the transaction should be approved or denied is a genuine response.

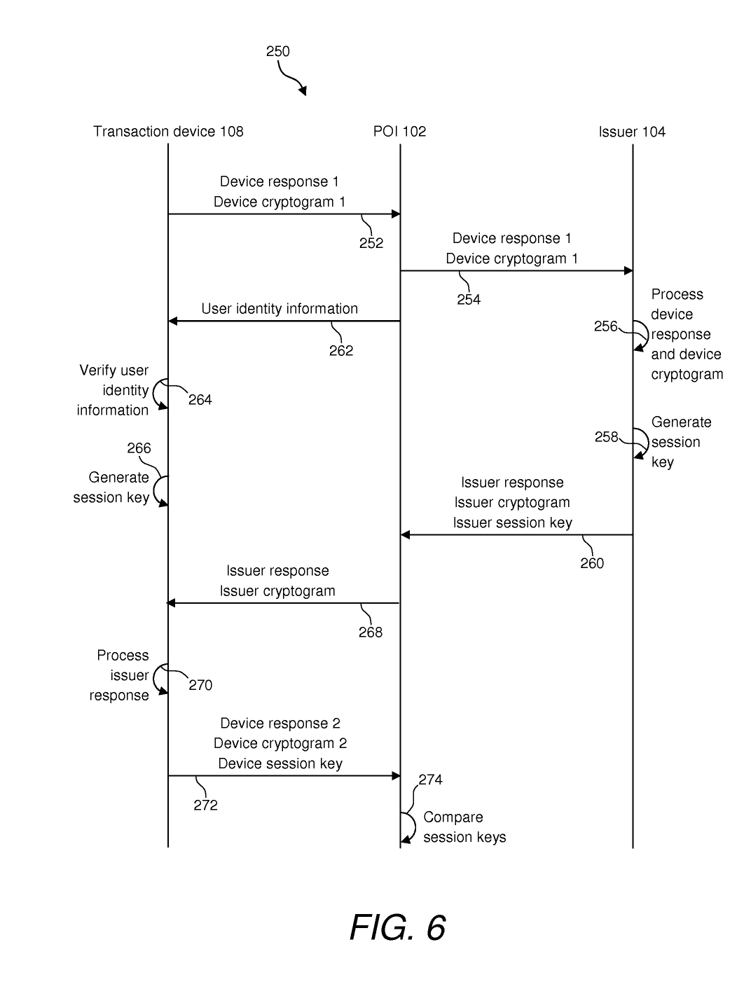

FIG. 6 shows an example dataflow 250 between the transaction device 108, the POI 102 and the issuer 104 in which the communications from the transaction device 108 are authenticated. Once the transaction device 108 and the POI 102 form a temporary connection between the I/O module 132 of the POI 102 and the I/O module 152 of the transaction device 108 for carrying out a payment transaction, the transaction device 108 sends, at Step 252, transaction data comprising a first device response and a first device cryptogram to the POI 102. The POI 102 then forwards, at Step 254, the transaction data to the issuer 104.

Following this, the issuer 104 processes, at Step 256, the first device response and the first device cryptogram to check if the transaction is valid. The issuer 104 uses the information associated with the transaction device 108 in the database 184 to determine whether the transaction should be approved or denied based on the transaction data in the first device response and the first device cryptogram. The issuer 104 determines the allowability of the transaction that is conditional on successful identity verification of the user of the transaction device 108. In other embodiments, the issuer 104 response is not conditional on identity verification of the user.

The session key generator 186 of the issuer 104 generates, at Step 258, a session key for the transaction. The response of the issuer 104 regarding the allowability of the transaction and the session key are then sent, at Step 260, back to the POI 102.

After the transaction device 108 sends, in Step 252, the first device response and the first device cryptogram to the POI 102, the display 140 indicates to the user to provide information associated with them that can be used to verify their identity (e.g. the user's PIN). The POI 102 sends, at Step 262, the information associated with the user to the transaction device 108.

Upon receiving the information associated with the user, the transaction device processor 150 verifies, at Step 264, that the user is authorized to use the transaction device 108. This verification is done by comparing the received information associated with the user with the information associated with the user stored in the memory 154.

Then the session key generator 156 of the transaction device 108 generates, at Step 266, a session key for the transaction.

The response of the issuer 104 sent, at Step 260, is forwarded, at Step 268, to the transaction device 108. The transaction device 108 processes, at Step 270, the response of the issuer 104. Then the transaction device 108 sends, at Step 272, a second device response along with a second device cryptogram and the session key generated, at Step 266. The second device response comprises information including whether the identity of the user was successfully verified.

The POI 102 then compares, at Step 274, the session key from the transaction device 108 and the session key from the issuer 104 to determine whether they match. If they match, then the POI 102 can trust that the second device response is valid. Accordingly, the response received by the POI 102 regarding whether the user is authorized to use the transaction device 108 is a genuine response.

Steps 262, 264 and 266 may be carried out substantially at the same time as Steps 254, 256, 258, 260 and 268. Carrying out these steps in parallel reduces the overall time required to carry out the transaction.

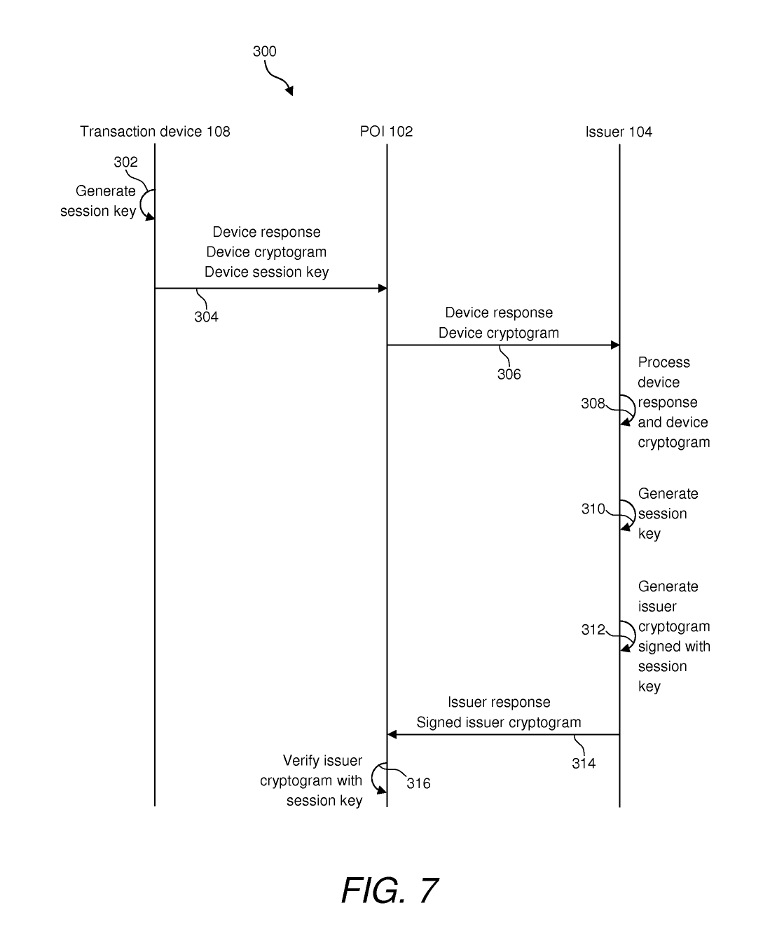

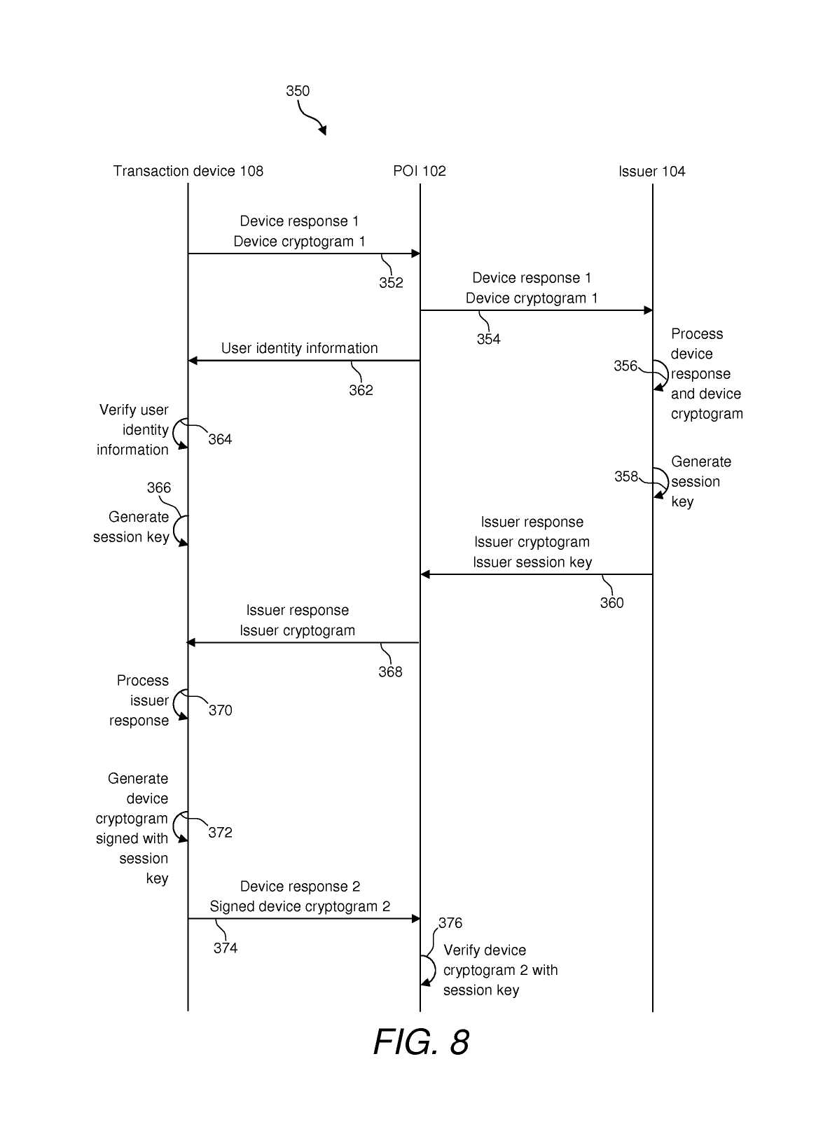

The data flows of FIGS. 7 and 8 are substantially similar to the data flows of FIGS. 5 and 6 respectively. However, in the embodiments described with reference to FIGS. 7 and 8, the transaction device 108 and the issuer 104 do not both send the session key to the POI 102. Instead, one device sends the session key and the other device sends data associated with the session key, for example, a response or cryptogram signed with the session key. The POI 102 then verifies the signed cryptogram or response using the received session key. This is discussed in more detail below.

FIG. 7 shows an example dataflow 300 between the transaction device 108, the POI 102 and the issuer 104 in which the communications from the issuer 104 are authenticated. Once the transaction device 108 and the POI 102 form a temporary connection between the I/O module 132 of the POI 102 and the I/O module 152 of the transaction device 108 for carrying out a payment transaction, the session key generator 156 of the transaction device 108 generates, at Step 302, a session key for the transaction. Then the transaction device 108 sends, at Step 304, a device response, a device cryptogram and a session key to the POI 102. The POI 102 forwards, at Step 306, the device response and the device cryptogram to the issuer 104 via the network 106.

Following this, the issuer 104 processes, at Step 308, the device response and the device cryptogram to check if the transaction is valid. The issuer 104 uses the information associated with the transaction device 108 in the database 184 to determine whether the transaction should be approved or denied based on the transaction data comprising the device response and the device cryptogram.

The session key generator 186 of the issuer 104 generates, at Step 310, a session key for the transaction. The issuer 104 then generates, at Step 312, a cryptogram that is signed with the session key.

The response of the issuer 104 regarding the allowability of the transaction and the signed issuer cryptogram are then sent, at Step 314, back to the POI 102. The POI 102 then verifies, at Step 316, the signed issuer cryptogram using an authentication algorithm and the session key from the transaction device 108 to infer the session key generated by the issuer 104. If the issuer cryptogram is successfully verified, then the POI 102 can trust that the issuer response is valid. Accordingly, the response received by the POI 102 regarding whether the transaction should be approved or denied is a genuine response.

FIG. 8 shows an example dataflow 350 between the transaction device 108, the POI 102 and the issuer 104 in which the communications from the transaction device 108 are authenticated. Once the transaction device 108 and the POI 102 form a temporary connection between the I/O module 132 of the POI 102 and the I/O module 152 of the transaction device 108 for carrying out a payment transaction, the transaction device 108 sends, at Step 352, transaction data comprising a first device response and a first device cryptogram to the POI 102. The POI 102 then forwards, at Step 354, the transaction data to the issuer 104.

Following this, the issuer 104 processes, at Step 356, the first device response and the first device cryptogram to check if the transaction is valid. The issuer 104 uses the information associated with the transaction device 108 in the database 184 to determine whether the transaction should be approved or denied based on the transaction data in the first device response and the first device cryptogram. The issuer 104 determines the allowability of the transaction that is conditional on successful identity verification of the user of the transaction device 108. In other embodiments, the issuer response is not conditional on identity verification of the user.

The session key generator 186 of the issuer 104 generates, at Step 358, a session key for the transaction. The response of the issuer 104 regarding the allowability of the transaction and the session key are then sent, at Step 360, back to the POI 102.

After the transaction device 108 sends in, Step 352, the first device response and the first device cryptogram to the POI 102, the display 140 indicates to the user to provide information associated with them that can be used to verify their identity (e.g. the user's PIN). The POI 102 sends, at Step 362, the information associated with the user to the transaction device 108.

Upon receiving the information associated with the user, the transaction device processor 150 verifies, at Step 364, that the user is authorized to use the transaction device 108. This verification is done by comparing the received information associated with the user with the information associated with the user stored in the memory 154.

Then the session key generator 156 of the transaction device 108 generates, at Step 366, a session key for the transaction.

The response of the issuer 104 sent, at Step 360, is forwarded, at Step 368, to the transaction device 108. The transaction device 108 processes, at Step 370, the response of the issuer 104. Then the transaction device 108 generates, at Step 372, a cryptogram that is signed with the session key.

Then the transaction device 108 sends, at Step 374, a second device response along with the signed second device cryptogram. The second device response comprises information including whether the identity of the user was successfully verified.

The POI 102 then verifies at, Step 376, the signed transaction device cryptogram using an authentication algorithm and the session key from the issuer 104 to infer the session key generated by the transaction device 108. If the transaction device cryptogram is successfully verified, then the POI 102 can trust that the transaction device response is valid. Accordingly, the response received by the POI 102 regarding whether the user is authorized to use the transaction device 108 is a genuine response.

Steps 362, 364 and 366 may be carried out substantially at the same time as Steps 354, 356, 358, 360 and 368. Carrying out these steps in parallel reduces the overall time required to carry out the transaction.

Many modifications may be made to the above examples without departing from the scope of the present disclosure as defined in the accompanying claims.

For example, the transaction device may comprise an identity information receiver instead of the POI. In this case a user may provide information to verify their identity before the transaction device performs any communication with a POI.

A further example is where the issuer 104 does not comprise an incrementer. Instead, an output value of the incrementer 158 of the transaction device 108 is sent to the issuer 104 with the first transaction device response (i.e. in Step 202, 252, 304 or 352). The output value is signed by the transaction device 108 so that the issuer 104 can trust the output value. Freshness of the session key (e.g. to prevent a replay attack, where the same input variables are provided) is ensured by a random value generated by the POI 102 and sent to the transaction device 108 and also signed by the transaction device 108 along with the output value of the incrementer 158. The POI 102 sends the random value to the issuer 104. The issuer 104 can then verify that the transaction device 108 has signed the random value so that this signature cannot be pre-computed and cannot be replayed as the random value is unpredictable and changes for every transaction. The issuer 104 receives the output value of the incrementer 158 and checks that it is fresh (i.e. has not been used before) and genuine by verifying the signature. The issuer 104 then uses the output value of the incrementer 158 of the transaction device 108 to compute the session key.

Although the present disclosure has been described in connection with specific embodiments, it should be understood that various changes, substitutions, and alterations apparent to those skilled in the art can be made to the disclosed embodiments without departing from the spirit and scope of the disclosure as set forth in the appended claims.

It should also be appreciated that the functions and/or steps and/or operations described herein, in some embodiments, may be described in computer executable instructions stored on a computer readable media (e.g., in a physical, tangible memory, etc.), and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

Further, it should be appreciated that one or more aspects of the present disclosure transform a general-purpose computing device into a special-purpose computing device when configured to perform the functions, methods, and/or processes described herein.

With that said, exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

In addition, the exemplary embodiments herein are only examples, and are not intended to limit the scope, applicability, operation, or configuration of the disclosure in any way. It will be further appreciated by a person skilled in the art that numerous variations and/or modifications may be made to one or more of the above-described embodiments without departing from the spirit or scope of the disclosure as broadly described in the appended claims. The above-described embodiments are, therefore, to be considered in all respects to be illustrative and not restrictive.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed. As used herein, the term “and/or” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

1. A method of authenticating a communication network comprising a first computing device, a second computing device and an intermediary computing device, wherein there is a first path between the first computing device and the intermediary computing device and a second path between the second computing device and the intermediary computing device, the method being executed at the intermediary computing device and comprising:
receiving, from the first computing device, a first session key, the first session key being generated by the first computing device using a function, wherein an input to the function comprises an incremented variable;
receiving, from the second computing device, data associated with a second session key, the second session key being generated by the second computing device using the function;
determining that the first session key and the second session key are the same; and
defining the communication network as authentic in the event that the first session key and the second session key are the same.

2. The method of authenticating a communication network of claim 1, wherein the data associated with the second session key is the second session key.

3. The method of authenticating a communication network of claim 2, wherein the step of determining comprises directly comparing the first session key and the second session key.

4. The method of authenticating a communication network of claim 1, wherein the data associated with the second session key is data signed by the second session key.

5. The method of authenticating a communication network of claim 4, wherein the step of determining comprises inferring the second session key from the data signed by the second session key, and determining that the first session key and the second session key are the same.

6. The method of authenticating a communication network of claim 1, wherein the incremented variable is either a count of the number of transactions carried out by the first computing device or a time.

7. (canceled)

8. The method of authenticating a communication network of claim 1, wherein the first session key is received with data associated with a transaction.

9. The method of authenticating a communication network of claim 1, wherein the second session key is received with data associated with a transaction.

10. The method of authenticating a communication network of claim 1, wherein the first computing device is a transaction device arranged to carry out transactions with the intermediary computing device.

11. The method of authenticating a communication network of claim 1, wherein the second computing device is an issuer entity arranged to validate transactions between the transaction device and the intermediary computing device.

12. The method of authenticating a communication network of claim 1, wherein the second computing device is a transaction device arranged to carry out transactions with the intermediary computing device.

13. The method of authenticating a communication network of claim 1, wherein the first computing device is an issuer entity arranged to validate transactions between the transaction device and the intermediary computing device.

14. The method of authenticating a communication network of claim 1, wherein the intermediary computing device is a point of interaction.

15. A non-transitory computer-readable storage medium storing executable computer program instructions which, when executed by a processor, cause the processor to, on an intermediary computing device:
receive, from a first computing device, a first session key, the first session key being generated by the first computing device using a function, wherein an input to the function comprises an incremented variable;
receive, from a second computing device, data associated with a second session key, the second session key being generated by the second computing device using the function;
determine that the first session key and the second session key are the same; and
define a communication network, comprising the intermediary computing device, the first computing device, and the second computing device, as authentic when the first session key and the second session key are the same.

16. An intermediary computing device suitable for authenticating a communication network, the communication network comprising a first computing device, a second computing device and an intermediary computing device, wherein there is a first path between the first computing device and the intermediary computing device and a second path between the second computing device and the intermediary computing device, the intermediary computing device comprising:
a first input, arranged to receive a first session key from the first computing device, the first session key being generated by the first computing device using a function, wherein an input to the function comprises an incremented variable;
a second input, arranged to receive data associated with a second session key from the second computing device, the second session key being generated by the issuer using the function;
a processor arranged to determine that the first session key and the second session key are the same, and define that the communication network is authentic in the event that the first session key is identical to the second session key.

17. The intermediary computing device of claim 16, wherein the data associated with the second session key is the second session key; and
wherein the processor is arranged to determine that the first session key and the second session key are the same by directly compare the first session key and the second session key.

18. (canceled)

19. The intermediary computing device of claim 16, wherein the data associated with the second session key is data signed by the second session key; and
wherein the processor is arranged to determine that the first session key and the second session key are the same by inferring the second session key from the data signed by the second session key, and determining that the first session key and the second session key are the same.

20. (canceled)

21. The intermediary computing device of claim 16, wherein the first input and the second input are the same.

22. The intermediary computing device of claim 16, comprising an output arranged to output a verification message to the first computing device or the second computing device, wherein the verification message comprises whether the communication was successfully authenticated by the intermediary computing device.

23. The intermediary computing device of claim 16, comprising a display and an output arranged to output a transaction outcome to the display.
